(19) United States
(12) Patent Application Publication
(10) Pub. No.: US 2007/0027582 A1
(43) Pub. Date: Feb. 1, 2007

(54) Device and method for measuring quantities of motion of a motor vehicle

(76) Inventor: Pascal Munnix, Munich (DE)

Correspondence Address: HARNESS, DICKEY & PIERCE, P.L.C., P.O. BOX 828, BLOOMFIELD HILLS, MI, 48303, US

(21) Appl. No.: 10/559,036

(22) PCT Filed: Jun. 7, 2004
(86) PCT No.: PCT/EP04/06136

§ 371 Date: Apr. 27, 2006

(30) Foreign Application Priority Data
Jun. 5, 2003 (DE) 103 25 548.6

(51) Int. Cl. G06F 17/00

(52) U.S. Cl. 701/1; 701/38; 701/300

(57) ABSTRACT

The invention relates to a device and a method for measuring motion quantities for the purpose of recognizing the driving status of a motor vehicle with the aid of a first sensor for measuring a motion quantity along a first direction in space and a second sensor for measuring the motion quantity along a second direction in space, the measuring direction of the first sensor forming an angle with the measuring direction of the second sensor. In this manner, a primary direction and an additional direction can be assigned to the two measuring directions of the sensors. The primary direction coincides with one of the two measuring directions of the sensors or it lies between the two measuring directions of the sensors so that both measuring directions of the sensors have a component along the primary direction. The additional direction is essentially perpendicular to the primary direction and lies in the plane defined by the two measuring directions of the sensors so that at least one of said measuring directions also has a component along the additional direction. The device is configured so that, on the one hand, two essentially redundant values of the motion direction are measured along the primary direction and, on the other, additionally the motion quantity along the additional direction is calculated from the values measured by the first sensor and the values measured by the second sensor.

The invention relates in general to devices and methods for measuring motion quantities and particularly to devices and a method for measuring motion quantities for the purpose of recognizing the driving status of a motor vehicle by means of sensors.

An important objective of driving dynamics control systems and safety systems of motor vehicles is to stabilize the motor vehicle in critical situations, for example when it begins to skid. The first serially introduced systems for achieving this objective were antiblock control systems (ABS) and traction control systems (TCS) which primarily act on the longitudinal dynamic performance of the motor vehicle. As a basic extension, driving dynamics control systems for motor vehicles were developed which took controlled measures, such as active braking of individual wheels, control of the drive torque to cause slipping at the wheels and/or to influence the performance of the vehicle in a stabilizing manner by active steering. Such systems are, for example, the electronic stability program (ESP) or the active front steering (AFS) for controlled steering action of BMW.

A common feature of all vehicle driving dynamics control systems is that, firstly, they must determine as accurately as possible the driving status, which requires motion sensors among other things. The more motion quantities and driving status parameters are known, the better and more reliably can, in principle, the driving status be determined and the more effectively and more safely an undesirable behavior of the motor vehicle can be counteracted. For example, the plausibility of the determined driving status can be checked by means of additional known motion quantities. Moreover, in unusual driving situations such as extremely sharp turns it may no longer be possible to ensure control and thus the stabilization of the vehicle without the use of such other motion quantities. To this end, however, as a rule, additional motion sensors are required which push up the cost of the driving dynamics control system or safety system of a motor vehicle. This explains the basic attempts of manufacturers of such systems to keep the number of needed sensor elements as low as possible, although in some cases, for safety reasons, is seems advisable at least for the most important motion sensors to use them in redundant manner so that for the measurement of all further motion quantities two sensor elements must be installed, which increases the cost correspondingly.

In view of this background, it is the object of the present invention to provide devices and methods that allow optimization of the measurement and determination of motion quantities with as few sensors as possible.

According to a first aspect, the invention provides a device for measuring motion quantities for the purpose of recognizing the driving status of a motor vehicle. The device comprises a first sensor for measuring a motion quantity along a first direction in space and a second sensor for measuring the motion quantity along a second direction in space, the measuring direction of the first sensor forming an angle with the measuring direction of the second sensor. In this manner, it is possible to assign to the two measuring directions of the sensors a primary direction and an additional direction. The primary direction coincides with one of the two measuring directions of the sensors or it lies between the two measuring directions of the sensors so that both measuring directions have a component along the primary direction. The additional direction is essentially perpendicular to the primary direction and lies in the plane defined by the two measuring directions of the sensor so that at least one of the two measuring directions also has a component along the additional direction. The device is designed so that, on the one hand, two essentially redundant values of the motion quantity are measured along the primary direction and, on the other, the motion quantity along the additional direction is also calculated from the measured values of the first sensor and the measured values of the second sensor.

According to another aspect, the invention provides a device for measuring motion quantities for the purpose of recognizing the driving status of a motor vehicle. The device comprises a set of first sensors for measuring a motion quantity along different directions, the directions of the sensor measurements forming a perpendicular system in a plane or in space. One sensor is selected from the set of first sensors and it is to be monitored. The device also comprises a second sensor for measuring a motion quantity in a second direction. The second direction of sensor measurement forms an acute angle with each of the measuring directions of the sensors of the perpendicular system so that said second direction has a component along each of the sensors' measuring directions. The device is designed so that from the measured values of the first sensor or sensors that are not to be monitored and the measured value of the second sensor, the motion quantity along the measuring direction of the first sensor that is to be monitored is calculated to obtain for it, for purposes of monitoring, a redundant second measured value.

According to yet another aspect, the invention is directed toward a method for measuring motion quantities for the purpose of recognizing the driving status of a motor vehicle whereby a motion quantity along a first direction in space is measured with a first sensor. The motion quantity is measured along a second direction in space with a second sensor, the measuring directions of the first and second sensor forming an angle. In this manner, it is possible to assign to the two measuring directions of the sensors a primary direction and an additional direction. The primary direction coincides with one of the two measuring directions of the sensors or lies between the two measuring directions of the sensors so that both measuring directions of the sensors have a component along the primary direction. The additional direction is essentially perpendicular to the primary direction and lies in the plane defined by the two measuring directions of the sensors so that at least one of the measuring directions of the sensors also has a component along the additional direction. Based on the measurements of the two sensors, two essentially redundant values of the motion quantity along the primary direction is determined. From the measured values of the first sensor and the measured values of the second sensor, the motion quantity along the additional direction is calculated.

In the following, the invention will be explained by reference to preferred exemplary embodiments and attached exemplary drawings of which:

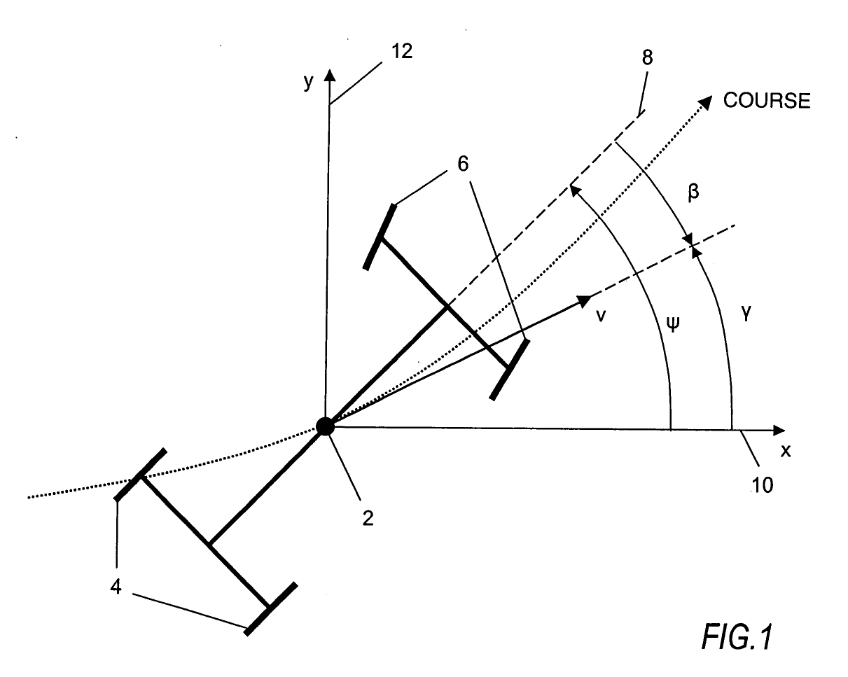

FIG. 1 is a schematic representation of the motion quantities of a motor vehicle;

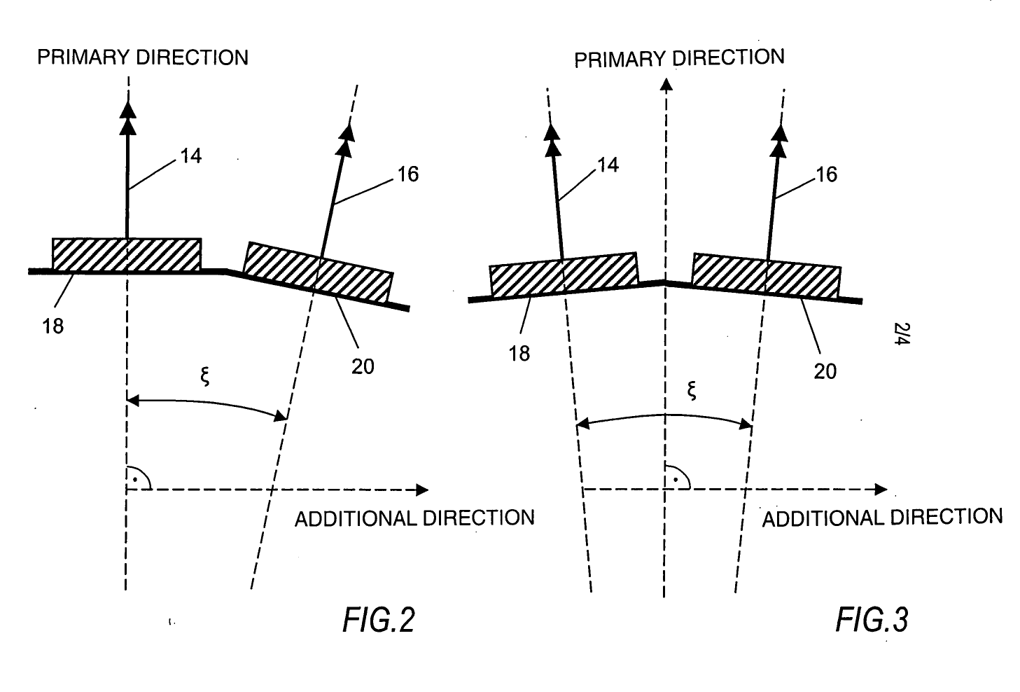

FIG. 2 is a schematic representation of the mutual orientation of two motion sensors according to a preferred embodiment;

FIG. 3 is a schematic representation of the mutual orientation of two motion sensors according to another preferred embodiment;

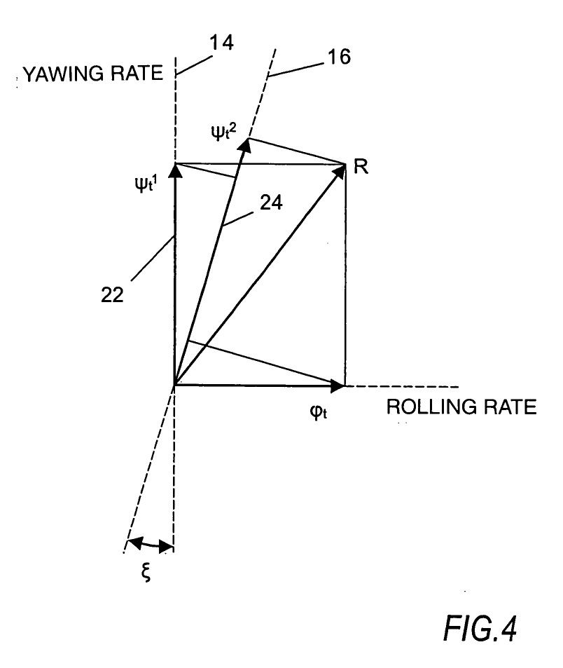

FIG. 4 is a schematic representation of the components of the two sensors showing a primary direction and an additional direction according to a preferred embodiment;

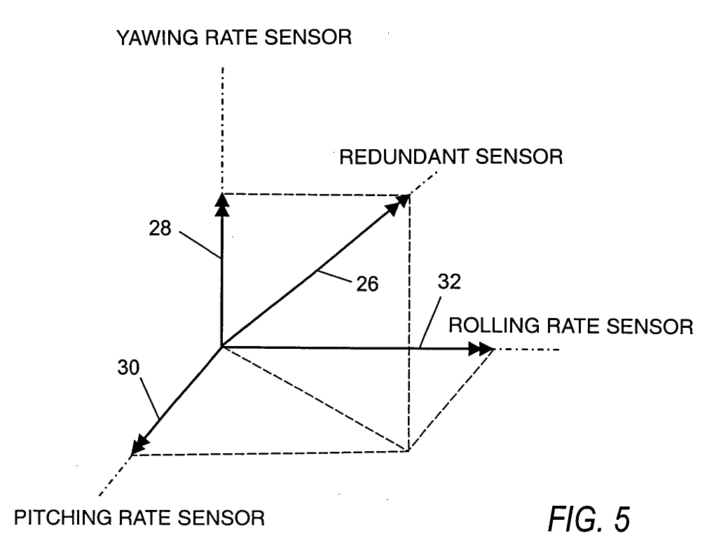

FIG. 5 is a schematic representation of the components of the motion sensors in space according to another preferred embodiment.

Many parameters can serve for the recognition of the driving status of a motor vehicle of which here are mentioned, for example, only the rotation speeds of the motor vehicle about various axes in space, the acceleration, the steering angle, the four wheel velocities, the drive torque or the brake pressure. A preferred embodiment concerns, in particular, the parameters related to motion quantities. The preferred parameters are, in particular, the yawing rate, an acceleration value, a velocity or a force, for example the force acting on the wheels. These motion quantities are preferably used for the driving dynamics systems or safety systems of motor vehicles, for example the airbag systems or rollover recognition systems.

The rotation rates are preferably rotation velocities about the main axes of the motor vehicle, namely along the longitudinal axis, transverse axis and vertical axis, which as a rule pass through the center of gravity of the motor vehicle. These motion quantities that are tied to the perpendicular main-axes coordinates of the motor vehicle are here referred to as canonical motion quantities. As regards the rotation rates, the yawing rate describes a rotation of the motor vehicle about its vertical axis, the rolling rate a rotation about the longitudinal axis of the motor vehicle, namely lateral tilting of the motor vehicle, and the pitching rate a rotation about the motor vehicle's transverse axis. The acceleration values of the motor vehicle are the transverse acceleration, the longitudinal acceleration and the vertical acceleration along the transverse, longitudinal and vertical axis of the motor vehicle, respectively.

In the preferred embodiments, these motion quantities are measured with the aid of known sensors. For example, transverse acceleration sensors are known which are based on the principle of a flexural sensor coupled with a condenser, whereas yawing rate sensors utilize, for example, the Coriolis effect for measuring the rotational movement.

By motor vehicle are meant here all kinds of vehicles, but particularly automobiles and trucks or buses, in which driving dynamics control systems or safety systems are used.

A preferred embodiment utilizes the fact that current motor vehicle dynamics control systems and safety systems contain sensors which for safety reasons are in part redundant, namely to measure a motion quantity, for example a yawing rate, in a spatial direction, there are provided two sensors or sensor elements giving two independent measured values. These two independent measured values are then used to monitor each other so that an error in one or both redundant sensors can be recognized very quickly. As a result, the probability that the sensor will operate with an erroneous input quantity can be markedly reduced. For example, it is possible to use as the criterion for a possible measurement error an excessive deviation of the two mutually independently measured values and then, for example, by means of plausibility checks to identify the faulty sensor and exclude it from the vehicle's control system. Even so, in such a case, on the basis of the second available measured value, the motor vehicle control system can continue to function faultlessly. On the other hand, for example by averaging the two measured values of the two redundant sensors, small statistical errors can be compensated for and the accuracy of the measurement thus improved. Both effects contribute considerably to the reliability of the driving dynamics control system of a motor vehicle.

Usually, the two redundant sensors are disposed parallel to one another in the direction of the motion quantity to be measured. According to a preferred embodiment, only a first sensor for measuring the motion quantity is oriented along a first direction in space and a second sensor for measuring the motion quantity is oriented in a second direction in space, the measuring direction of the first sensor forming an angle with the measuring direction of the second sensor. The measuring directions of the first and second sensor are thus not parallel. It is possible to assign to the two measuring directions of the sensors a primary direction and an additional direction. In a preferred embodiment, the primary direction coincides with one of the two measuring directions of the sensors and in another preferred embodiment the primary direction lies between the measuring directions of the two sensors. It does not necessarily lie symmetrically in the middle between these two measuring directions, but can also form different angles with one or the other measuring direction. Preferably, however, the primary direction forms the symmetry axis, namely it divides the angle between the measuring directions of the two sensors in half. As a result of this arrangement, both measuring directions have a component along the primary direction. The primary direction can, for example, be the vertical axis of the motor vehicle so that the motion quantity measured along this primary direction is, for example, the yawing rate.

The additional direction, on the other hand, is essentially perpendicular to the primary direction and lies in the plane defined by the measuring directions of the two sensors. Hence, in the case that the primary direction coincides with one of the sensors' two measuring directions, one of the two measuring directions in any case has a component along the additional direction, whereas, in the other case, even the measuring directions of both sensors have a component along the additional direction. This additional direction could, for example, be oriented along the longitudinal axis of the motor vehicle so that when a rotation rate is the motion quantity measured, the motion quantity represents the rolling rate along the additional direction.

The preferred embodiments are configured so that, on the one hand, they measure two essentially redundant values of the motion quantity along the primary direction and, on the other, from the measured values of the first sensor and those of the second sensor they also calculate the motion quantity along the additional direction. The angle between the two measuring directions of the two sensors thus leads to the fact that additionally another motion quantity can be determined, because at least one of the two sensors also measures a component of the motion quantity in said direction which, in view of the known geometry, can be calculated. On the other hand, when the angle between the measuring directions of the two sensors is small, the main part of the measured value of the slightly transverse-oriented sensor will stem from the component along the primary direction so that at least approximately a redundant value for the measurement along the primary direction can be obtained.

The angle between the measuring directions of the first and the second sensor is preferably a small angle.

The smaller this angle, the better will be the redundance. On the other hand, it must be taken into account that reducing the angle also reduces the signal along the additional direction A lower limit for the angle thus arises from the condition that a sufficient signal concerning the motion quantity must still be measurable in the additional direction to allow a reliable determination of the motion quantity in this direction. Preferably, therefore, the angle will be greater than 0° and less than 45°, a preferred range being between about 50° and 100°. The accurate determination of the optimum angle depends on the special boundary conditions of the driving dynamics control system of the vehicle and on the planned use range. A criterion for the determination of the optimum angle is the tolerance of the controller for errors in the measured value of the motion quantity along the primary direction which provides a guideline or a limiting range within which the deviations between the measured values of the two sensors should lie.

In a preferred embodiment, the calculated motion quantity along the additional direction is used directly as input to the controller of the driving dynamics system or safety system of the motor vehicle. This means, for example, that when the motion quantity along the additional direction represents the rolling rate of the motor vehicle, this calculated rolling rate also enters the control loop thus enriching the dynamics control system of the vehicle by another driving condition parameter without the need for another expensive sensor. For example, the controller can use this additionally acquired motion quantity to increase the accuracy of other control or setting quantities, to carry out plausibility checks on the driving status determined with the aid of the other motion quantities or to allow safe functioning even in extreme vehicle situations such as a pronounced lateral tilt and/or a sharp turn. By utilizing the, now already standard, two redundant sensor elements, it is possible, with the preferred embodiments, for an additional motion quantity to be made available to the driving dynamics control system of the vehicle without the need for additional expensive sensors and without having to omit the redundance which is, at least within certain limits, required for safety reasons.

In another preferred embodiment, the device comprises a third sensor which alone measures the motion quantity along the additional direction. The calculated value of the motion quantity along the additional direction is then used as the redundant value to monitor the measured value by this third sensor. In this embodiment, one does not gain a new motion quantity as this quantity is al-ready measured by the third sensor. Rather, the reliability of the system is increased, because this value, measured by just one sensor, can be monitored in redundant manner by a second measured value, it being possible optionally to take into account other driving status parameters to identify the faulty sensor.

In a preferred embodiment, the motion quantity represents a rotation rate. Most preferably, the motion quantity along the primary direction represents the yawing rate and the rotation rate along the additional direction represents the rolling rate or pitching rate of the motor vehicle.

In other preferred embodiments, the rotation rate along the primary direction is the rolling rate and the rotation rate along the additional direction is the yawing rate or pitching rate. In yet other embodiments, the rotation rate along the primary direction represents the pitching rate and the rotation rate along the additional direction represents the yawing rate or rolling rate of the motor vehicle. In other words, in the preferred embodiments, all possible combinations can be achieved.

The same is true for those embodiments in which the motion quantity represents an acceleration value. Here, too, within the framework of the preferred embodiments, any combination of the acceleration values along the main axes of the motor vehicle, namely of the transverse acceleration, longitudinal acceleration and vertical acceleration, is achievable for the primary direction and the additional direction. Most preferably, the acceleration value along the primary direction is the transverse acceleration of the motor vehicle, and the acceleration value along the additional direction is the longitudinal or vertical acceleration.

In the preferred embodiments described thus far, the motion quantity along the additional direction always coincided with the canonical motion quantity, namely with a motion quantity along the main axes of the motor vehicle, so that by calculating the motion quantity along this additional direction, a value for one of the canonical motion quantities was determined directly. In another preferred embodiment, the motion quantity along the primary direction is a canonical motion quantity, but along the additional direction it is not a canonical motion quantity, but a motion quantity along a direction lying in a plane defined by the two other directions of the canonical motion quantity. This means that the motion quantity along the primary direction is still a canonical motion quantity, but along the additional direction it is neither one nor the other of the remaining canonical motion quantities. Rather, the additional direction lies between the directions of the two remaining canonical motion quantities. The additional direction thus forms with said quantities an angle and is not necessarily in the middle, namely it does not divide the angle between these two main axes in half, but preferably also forms with one of the two main axis a, preferably small, angle.

According to a preferred embodiment, this configuration opens up two other application possibilities. In another preferred embodiment, the device is provided with a third and a fourth sensor that measure the motion quantity along the directions of the two other canonical motion quantities. The calculated motion quantity along the additional direction which does not coincide with the measuring direction of either the third or the fourth sensor and preferably forms with these directions a 45° angle, thus serves as an additional redundant value for monitoring the measured values of the third and fourth sensor. In other words, with the aid of the calculated motion quantity along this additional direction it is possible to monitor the value measured by the fourth sensor with the aid of the value measured by the third sensor or, viceversa, monitor the value measured by the third sensor with the aid of the value measured by the fourth sensor. This means, assuming that one of the two sensors gives faulty measurements, that it is possible to monitor the other sensor and, of course, doing this alternately as well.

In the case of the other application possibility, in another preferred embodiment there is provided only a third sensor that measures the motion quantity along one first direction of the two other canonical motion quantities, the measuring direction of said third sensor forming a, preferably small, angle with the additional direction. The calculated motion quantity along the additional direction serves, on the one hand, as a redundant value for monitoring the value measured by the third sensor and, on the other, it also serves to calculate the motion quantity along the second direction of the two other canonical motion quantities from the value measured by the third sensor and the calculated motion quantity along the additional direction. In this manner, it is possible to omit one, namely the fourth, sensor and still be able to determine the motion quantity along its direction of measurement, for which at the same time there is available a redundant value for the motion quantity along the measuring direction of the third sensor. In this manner, the arrangement of the sensors' measuring directions which are slightly inclined to one another can be used for a second time, this time additionally in the plane defined by the two other canonical motion quantities that do not correspond to the primary direction. Hence, what was stated hereinabove applies also to the determination and optimization of the angle between the measuring direction of the third sensor and the additional direction, namely the angle should preferably be greater than 0° and smaller than 45° and most preferably should be between about 50° and 100°.

In other words, in the first application possibility, the yawing rate can, for example, be monitored redundantly with two sensors while the additional direction is oriented so that it lies in angle-halving manner between the directions of the rolling rate and the pitching rate as a result of which either the pitching rate is redundantly controlled when it is assumed that the rolling rate is error-free, or the rolling rate is redundantly controlled when it is assumed that the pitching rate is error-free. In the case of the second application possibility, the yawing rate, for example, can be redundantly monitored with two sensors and the rolling rate measured with the third sensor, in which case, when the additional direction is oriented so that with the rolling rate direction it forms a, preferably small, angle, the calculated value of the rotation rate along the additional direction can, on the one hand, be used for redundant monitoring of the measured value of the rolling rate sensor and, on the other, for determining another value for the pitching rate without the need for a sensor.

In the present description, the term sensor is meant in the functional sense, namely as a measuring unit capable of measuring a motion quantity along a direction in space. In a preferred embodiment, therefore, the sensors used can be designed as individual sensor elements, each with a stand-alone housing, control etc. In another preferred embodiment, these sensors are configured into a sensor cluster combining some or all sensors of the device into a unit, namely the individual sensor elements are, for example, disposed in a housing and can thus be installed or removed together. For example, such a sensor cluster can contain yawing rate sensors, transverse acceleration sensors and longitudinal acceleration sensors all or some of which are con-figured as a redundant sensor pair.

In a preferred embodiment, not the individual sensor elements but entire sensor clusters are tilted at an angle to each other. Some of these sensor clusters are produced in standard fashion and, hence, are more advantageous. Preferably, two identical sensor clusters are installed so that corresponding sensor elements are configured redundantly. In this case, the sensor elements of a sensor cluster are connected rigidly to one another. If according to the preferred embodiment the measuring directions of two sensors, for example the two yawing rate sensors and the two pitching rate sensors, are to be tilted relative to each other at a, preferably small, angle, then, be-cause of the inclination of the rigidly interconnected sensor elements of the particular sensor clusters, the sensor elements are flipped out of their main plane. As a result, they may have a component along another main axis. For example, if the sensors of a sensor cluster pair each with a yawing rate sensor and a rolling rate sensor are first tilted to one another out of the configuration parallel to the main axes by a, preferably small, angle so that the yawing rate sensors additionally contain a component of the rolling rate, and are then flipped about the vertical axis, also by a, preferably small, angle so that the rolling rate sensors additionally receive a component of the pitching rate, then the yawing rate sensors also receive a component of the pitching rate which may generate an error in its redundant measurement of the yawing rate. Because of the small angle, however, this error is acceptable and in this embodiment it is a trade-off for the advantage of being able to use standardized sensor clusters.

In another preferred embodiment, the goal is to monitor redundantly a set of first sensors by means of a second sensor, always assuming that the first sensors which are not directly monitored function flawlessly. Naturally, the monitoring can be carried out in the opposite manner, with all sensors of the set of first sensors being monitored redundantly by first sensors. To this end, in this preferred embodiment there is a set of first sensors for measuring a motion quantity along different directions, with the measuring directions of the sensors forming a perpendicular system in a plane or in space. The value measured by a sensor should in this case be monitored redundantly. Moreover, in this preferred embodiment there is a second sensor for measuring a motion quantity along a second direction, the second measuring direction forming an acute angle with each of the sensors' measuring directions of the perpendicular system so that said second measuring direction has a component along each of the sensors' measuring directions of the perpendicular system. From the values measured by the first sensors that are not to be monitored and the value measured by the second sensor, it is possible to calculate the motion quantity along the direction of measurement of the first sensor that is to be monitored to obtain a second redundant measured value for monitoring purposes.

This preferred embodiment can be created both in a plane and in tridimensional space. In the first case, the set of first sensors comprises two sensors the measuring directions of which are oriented perpendicular to one another and of which one is to be monitored. The second sensor lies in the plane defined by the two first sensors. In the tridimensional case, the set of first sensors comprises three sensors the measuring directions of which are perpendicular to one another.

The preferred motion quantity in this case is a rotation rate or an acceleration value of the motor vehicle, particularly preferred being the canonical motion quantities along the main axis of the motor vehicle, namely the yawing rate, rolling rate or pitching rate in the case of rotation rates or the transverse acceleration, longitudinal acceleration or vertical acceleration in the case of the acceleration values of a motor vehicle.

Hence, in a preferred embodiment there are three first sensors, namely rotation rate sensors along the main axes of the motor vehicle, that is to say a yawing rate sensor, a rolling rate sensor and a pitching rate sensor, and additionally a second sensor oriented, for example, along the diagonal space direction. Overall, in this embodiment there are four sensors so that three rotation rates can be monitored redundantly. The second sensor in the diagonal space direction then monitors the measured values of the other three sensors. In the case of the monitoring of, for example, the yawing rate, the measured values for the rolling rate and the pitching rate then have to be assumed to be error-free. From the known geometry of the arrangement of the sensors, it is then possible to calculate the component of the second sensor relative to the monitored sensor direction when the measured values for the two other not directly monitored sensor directions are known.

Preferably, the sensor's second measuring direction is along the diagonal direction in the plane or along a diagonal direction in space. This means that this direction forms with the measuring directions of the first sensors a 45° angle.

In a preferred embodiment, the rolling rate calculated along the additional direction is used to calculate the rolling angle of the motor vehicle. By rolling angle of the motor vehicle is meant the lateral inclination of the motor vehicle to the horizontal as it occurs on laterally pitched road surfaces, in excessively sharp turns or in a lateral rollover of the motor vehicle. In a preferred embodiment, the lateral inclination calculated in this manner is used for correcting a measured transverse acceleration with which the float angle velocity of the motor vehicle can be calculated. This velocity is an important quantity for evaluating the stability of the motor vehicle and, hence, an important parameter for the dynamics control system of the vehicle. Stated in simpler terms, the float angle velocity corresponds to the skidding velocity of the motor vehicle.

The float angle β is usually defined, as shown in FIG. 1, as the difference between the yawing angle ψ by and the course angle γ. The yawing angle ψ represents the angle of rotation of the motor vehicle about the vertical axis, namely about a vertical axis through the center of gravity 2 of the motor vehicle, and the course angle γ defines the direction of movement of the center of gravity of the motor vehicle. Yawing angle ψ is measured relative to a coordinate axis 10, namely the x-axis, and thus gives the angle position of the longitudinal axis 8 of the motor vehicle relative to this axis 10. Course angle γ, on the other hand, describes the orientation of velocity vector v of center of gravity 2 of the motor vehicle which is tangential to the course of the motor vehicle, relative to the same coordinate axis 10. The deviations of these two angles or of their angle velocities, are a measure of the drifting or skidding of the motor vehicle. They are independent of the selection of a special system of coordinates 10, 12. Moreover, in FIG. 1 the reference numerals 4 and 6 denote the wheel position of the rear and front wheels, respectively.

For the change with time of float angle β, namely of the float angle velocity βₜ, the following relationship is thus obtained:
βₜ=ψₜ−Yₜ
wherein ψₜ and Yₜ denote the derivatives with respect to time of the yawing angle and course angle, respectively, namely the yawing angle velocity and the course angle velocity, respectively.

In a preferred embodiment, the yawing angle velocity ψₜ is measured by means of the yawing rate sensors whereas the course angle velocity Yₜ can be obtained from the transverse acceleration of the motor vehicle a_{q} and the course velocity v by use of the motion equation Yₜ =a_{q}/v. As a result, the following equation is obtained for the float angle velocity βₜ:
βt =ψₜ−a_{q}/v

This equation, however, is valid only when the road surface has no lateral inclination. If the road surface is laterally inclined as in sharp turns, the measured transverse acceleration a_{q} must be corrected by a component a_{q} ^{incl} acting as a result of the acceleration of gravity so that the following relationship is obtained for the float angle velocity βₜ:
βt=ψₜ−(a_{q}−a_{q}^{incl})/v
wherein a_{q}^{incl} indicates the transverse acceleration that would have been measured had the motor vehicle been standing on this spot.

The correction term a_{q}^{incl}, used because of the lateral inclination is of the same order of magnitude as are typical transverse accelerations of the motor vehicle in curves and, hence, cannot be neglected in the determination of the float angle velocity βₜ. Because the lateral inclination is usually not known, however, if the road surface exhibits a certain lateral inclination, an error is committed in the estimation of the float angle velocity βₜ an error that increases with increasing lateral inclination. As a result of this error, the dynamics control system of the vehicle could interpret a lateral inclination erroneously as a nonexistent instability and make an undesirable positional intervention, for example in the form of countersteering or braking.

To prevent such positional interventions, large tolerances would have to be provided for the controller which, however, would cause a general reduction in controller efficiency and sensitivity. Alternatively, at least slow changes and stationary lateral inclinations could be measured directly through the transverse acceleration. This, however, is possible only if the motor vehicle is still in a stable condition. An additional rolling rate sensor with which even fast changes in lateral inclination could be measured under all boundary conditions, namely particularly also under unstable driving conditions, for example during skidding, is usually not considered because of cost.

For this reason, in a preferred embodiment the yawing rate of the motor vehicle is measured redundantly in the primary direction and the rolling rate is selected as the additional direction. In this manner, the lateral inclination can be determined by integration of the rolling rate. To equalize this integration at regular intervals, the lateral inclination in the stable condition of the motor vehicle is then advantageously determined by means of a transverse acceleration sensor. In this manner, fast lateral inclination changes can also be determined by integration of the rolling rate.

FIGS. 2 and 3 three show two preferred variants of the relative orientation in space of the first measuring direction 14 of the first sensor 18 and of the second measuring direction 16 of the second sensor 20. In the variant shown in FIG. 2, the first measuring direction 14 of first sensor 18 is parallel to the primary direction and has no component along the additional direction which is oriented perpendicular to the primary direction. The primary direction is, for example, one of the main axes of the motor vehicle so that first sensor 18 measures along this primary direction, for example, the yawing, rolling or pitching rate or the transverse, longitudinal or vertical acceleration of the motor vehicle. In this case, the second measuring direction 16 of the second sensor 20 is oriented so that with the primary direction it forms a, preferably small, angle ξ. The measuring direction 14 of the first sensor, the measuring direction 16 of the second sensor and the additional direction in this case lie in the same plane so that the measuring direction 16 of the second sensor has a component along the additional direction as well as along the primary direction, the larger of the components, because of the small angle ξ, being the one along the primary direction. The additional direction is perpendicular to the primary direction. Thus, the second sensor 20 measures an essentially redundant second value for the motion quantity along the primary direction and at the same time, because of its small component along the additional direction, gives a further measured value for the motion quantity along the additional direction.

In the variant shown in FIG. 3, on the other hand, none of the two measuring directions 14 and 16 of the two sensors is parallel to the primary direction. Rather, they are oriented symmetrically relative to said primary direction and form an angle ξ2 with each other. In this variant, too, the first measuring direction 14 of the sensor, the second measuring direction 16 of the sensor, the primary direction and the additional direction lie in the same plane. As a result, each of the sensors 18 and 20 has a main component along the primary direction and they give two redundant values for the motion quantity along this direction, and a small secondary component along the additional direction for an additional measurement of the motion quantity along this direction.

FIG. 4 shows the geometry of the measuring directions of the sensors and the components thereof along various directions for the case of the preferred embodiment according to the variant of FIG. 2, wherein the yawing rate ψₜ¹ is measured as the primary direction parallel to the vertical axis of the motor vehicle and the rolling rate φₜ is measured parallel thereto along the longitudinal axis of the motor vehicle. The second measuring direction that is inclined by an angle ξ in this case measures a rotation rate ψₜ² containing both components of yawing rate ψₜ¹ and components of rolling rate φₜ. The rotational motion vector R represents any rotation of the motor vehicle consisting of both a rotation about the vertical axis of the motor vehicle (yawing rate) and a rotation about the longitudinal axis of the motor vehicle (rolling rate). Such a rotational motion vector R exists, for example, when the motor vehicle in entering a steep sharp turn begins to skid. The two sensors 18 and 20 indicate such a rotational motion R by a measurement of components 22 or 24 along the first measuring direction 14 or the second measuring direction 16 of the sensors, components that constitute projections of vector R on measuring directions 14 and 16 of the sensors. Knowing angle ξ between the two measuring directions 14 and 16 of the sensors, the corresponding rolling rate φₜ can then be obtained from the two measured values ψₜ¹ and ψₜ² by use of the following equation:
ψₜ²=ψₜ¹ cos(ξ)+φₜ sin(ξ)
or when solved
φₜ=[ψₜ² −ψt¹ cos(ξ)]/sin(ξ)

The second term φₜ sin(ξ) in the first equation represents the error committed when the two mea-sured values ψₜ² and ψₜ¹ cos(ξ) are considered as two fully redundant measured values that are corrected geometrically only by the factor cos(ξ). When angle ξ is small, however, the factor sin(ξ) is so small that at least in situations that are relevant here this second term may be ac-cepted for a redundant control. For example, for an angle ξ=60° this factor has a value of 0.1 so that a possibly present rolling rate contributes to this error with only 10% of its value. For rolling rates arising in practical situations, for example in laterally inclined sharp turns, this error is sufficiently small so that there are two essentially redundant measured values of the yawing rate.

If the deviation between the measured values of the first and the second sensor, namely between ψₜ¹ and ψₜ²cos(ξ), exceeds a certain threshold value, then in a preferred embodiment of the sys-tem certain measures are taken. Such measures can consist, for example, of the system increasing the tolerance of the controller, reducing the controller amplification or shutting the controller off altogether. Such a threshold value is, for example, 3° per second, which, for example, represents a tolerable upper limit of the yawing rate error of a driving dynamics controller. Such a significant deviation can stem either from the measuring error of one of the sensors or from a rolling rate that is unrealistic for common road inclinations, as would occur, for example, in a rollover, it not being possible, without further information, to differentiate between the two sources of error. In the final analysis, this, however, is not critical, because the adequate reaction when such a deviation takes place both in the case of a significant error of one of the two sensors as in the case of an unrealistic rolling rate, for example because of a rollover, is in both cases the same controller measure, namely, for example, shutting off the controller. Preferably, an attempt will also be made to use additional available information and status parameters for the purpose of identifying the source of error so that the controller's efficacy can be maintained.

FIG. 5 shows a schematic representation of a spatial sensor arrangement in a preferred embodiment in which three motion sensors are disposed perpendicular to one another so as to form a perpendicular system in space. With these sensors, the yawing rate, the rolling rate and the pitching rate of the motor vehicle are measured. The measuring direction of an additional, redundant sensor is oriented in space so as to form an acute angle with the other three sensors, namely it is neither parallel with nor perpendicular to the measuring directions of the other three motion sensors. In the case represented in FIG. 5, the motion quantity 26 measured with the redundant sensor has a component 28 along the direction of the yawing rate, a component 32 along the direction of the rolling rate and a component 30 along the direction of the pitching rate. If now, for example, the measurement of the yawing rate and of the rolling rate is assumed to be free of error, for example based on plausibility considerations, then from these two rates, with the aid of the measurement by the redundant sensor, the value measured by the pitching rate sensor can be checked in redundant manner. Thus, one of the sensors' measuring directions for the yawing rate, rolling rate or pitching rate can be monitored in redundant manner by means of the two other sensors and with the aid of the value measured by the redundant sensor. Preferably, this can also take place alternately so that alternately one of the three sensors is redundantly monitored along the main axes of the motor vehicle. In this manner, three independent sensors can be monitored by a single additional redundant sensor.

1. Device for measuring motion quantities for the purpose of recognizing the driving status of a motor vehicle, having
a first sensor for measuring a motion quantity along a first direction in space, and
a second sensor for measuring the motion quantity along a second direction in space, the first measuring direction and the second measuring direction of the sensors forming an angle,
so that a primary direction and an additional direction can be assigned to the two measuring directions of the sensors, the primary direction coinciding with one of the two measuring directions of the sensors or lying between the two measuring directions of the sensors, and wherein the additional direction is essentially perpendicular to the primary direction and lies in the plane defined by the two measuring directions of the sensors, so that at least one of the two measuring directions of the sensors also has a component along the additional direction, the device being configured so that
on the one hand, two essentially redundant values of the motion quantity are measured along the primary direction and
on the other hand, additionally a motion quantity along the additional direction is calculated from the values measured by the first sensor and the values measured by the second sensor.

2. Device as defined in claim 1, configured so that the calculated motion quantity along the additional direction is used (i) directly as input for the driving dynamics control system or for the safety system of the motor vehicle or (ii) as redundant value for monitoring the value measured by a third sensor that measures the motion quantity along the additional direction.

3. Device as defined in claim 1 configured so that the motion quantity is a rotation rate, an acceleration value, a velocity or a force.

4. Device as defined in claim 3, configured so that the motion quantity along the primary direction is one of the canonical motion quantities along the main axes of the motor vehicle, namely the yawing rate, rolling rate or pitching rate as rotation rates of the motor vehicle or, as an acceleration value of the motor vehicle, the transverse acceleration, longitudinal acceleration or vertical acceleration.

5. Device as defined in claim 4, configured so that the rotation rate along the primary direction is the yawing rate and the rotation rate along the additional direction is the rolling rate or the pitching rate of the motor vehicle.

6. Device as defined in claim 4, configured so that the rotation rate along the primary direction is the rolling rate of the motor vehicle and the rotation rate along the additional direction is the yawing rate or pitching rate of the motor vehicle.

7. Device as defined in claim 4, configured so that the rotation rate along the primary direction is the pitching rate of the motor vehicle and the rotation rate along the additional direction is the yawing rate or rolling rate of the motor vehicle.

8. Device as defined in claim 4, configured so that the acceleration value along the primary direction is the transverse acceleration of the motor vehicle and the acceleration value along the additional direction is the longitudinal acceleration or vertical acceleration of the motor vehicle.

9. Device as defined in claim 4, configured so that the acceleration value along the primary direction is the longitudinal acceleration of the motor vehicle and the acceleration value along the additional direction is the transverse acceleration or the vertical acceleration of the motor vehicle.

10. Device as defined in claim 4, configured so that the acceleration value along the primary direction is the vertical acceleration of the motor vehicle and the acceleration value along the additional direction is the transverse acceleration or the longitudinal acceleration of the motor vehicle.

11. Device as defined in claim 4, configured so that the motion quantity along the primary direction is a canonical motion quantity along the main axes of the motor vehicle, but the motion quantity along the additional direction is not a canonical motion quantity but, rather, a motion quantity along one of the directions lying in a plane formed by the two other directions of the canonical motion quantity.

12. Device as defined in claim 11, having a third and a fourth sensor that measure the motion quantities along the directions of the two other canonical motion quantities and that are configured so that the calculated motion quantity along the additional direction serves as an additional redundant value for the purpose of monitoring the third and fourth sensor.

13. Device as defined in claim 11, having a third sensor that measures the motion quantity along a first direction of the two other canonical motion quantities, and this third measuring direction of the sensor forms an angle with the additional direction, the calculated motion quantity along the additional direction, on the one hand, serving as redundant value for the purpose of monitoring the measured value of the third sensor and, on the other, additionally the motion quantity along the second direction of the two other canonical motion quantities is calculated from the measured value of the third sensor and the calculated motion quantity along the additional direction.

14. Device as defined in claim 1, configured so that the primary direction divides in half the angle between the two measuring directions of the sensors.

15. Device as defined in claim 1, configured so that the angle is greater than 0° and smaller than 45°.

16. Device as defined in claim 1, configured so that the angle is between about 5° and 10°.

17. Device as defined in claim 1, configured so that the sensor or sensors (i) are individual sensor elements or (ii) are configured as sensor clusters combining a few or all sensors of the device into a unit.

18. Device for measuring motion quantities for the purpose of recognizing the driving status of a motor vehicle, having:
a set of first sensors for measuring a motion quantity along different directions, the measuring directions of said sensors forming a perpendicular system in a plane or in space, a sensor being selected from the set of first sensors the measured value of which sensor is to be monitored;
a second sensor for measuring a motion quantity along a second direction, the second measuring direction of the sensor forming an acute angle with each of the measuring directions of the sensors of the perpendicular system so that it has a component along each measuring direction of the sensors of the perpendicular system;
the device being configured so that the motion quantity along the measuring direction of the first sensor to be monitored is calculated from the measured values of the first sensor or first sensors that are not to be monitored and the measured value of the second sensor, for the purpose of obtaining for said sensor a redundant second measured value for monitoring purposes.

19. Device as defined in claim 18 wherein the set of first sensors comprises two sensors the measuring directions of which are oriented perpendicular to one another and one of which is to be monitored, and wherein the second sensor lies in the plane formed by the two first sensors.

20. Device as defined in claim 18 wherein the set of first sensors comprises three sensors the measuring directions of which are oriented perpendicular to one another.

21. Device as defined in claim 18 wherein the motion quantity is a rotation rate or an acceleration value.

22. Device as defined in claim 18 wherein the motion quantity is one of the canonical motion quantities along the main axes of the motor vehicle, namely the yawing rate, rolling rate or pitching rate of the motor vehicle or, as an acceleration value of the motor vehicle, the transverse acceleration, longitudinal acceleration or vertical acceleration.

23. Device as defined in claim 18, configured so that the second measuring direction of the sensor is oriented along a diagonal in a plane or a diagonal in space.

24. Method for measuring motion quantities for the purpose of recognizing the driving status of a motor vehicle comprising the following steps:
measuring a motion quantity along a first direction in space with a first sensor;
measuring a motion quantity along a second direction in space with a second sensor, the first measuring direction forming an angle with the second measuring direction of the sensors,
so that the two measuring directions of the sensors can be assigned a primary direction and an additional direction, the primary direction coinciding with one of the two measuring directions of the sensors or lying between the two measuring directions of the sensors so that both measuring directions have a component along the primary direction, and the additional direction is essentially perpendicular to the primary direction and lies in the plane defined by the two measuring directions of the sensors so that at least one of said two measuring directions also has a component along the additional direction,
based on measurements of the two sensors, determining two essentially redundant values of the motion quantity along the primary direction, and
calculating the motion quantity along the additional direction from the values measured by the first sensor and the values measured by the second sensor.

25. Method as defined in claim 24 which also comprises the following steps: using the calculated motion quantity along the additional direction (i) directly as input for the driving dynamics control system or the safety system of the motor vehicle or (ii) as redundant value for monitoring the value measured by a third sensor that measures the motion quantity along the additional direction.

26. Method as defined in claim 24 wherein the motion quantity is a rotation rate or an acceleration value.

27. Method as defined in claim 26, wherein the motion quantity along the primary direction is a canonical motion quantity along the main axes of the motor vehicle, namely the yawing rate, rolling rate or pitching rate or, as an acceleration value of the motor vehicle, the transverse acceleration, longitudinal acceleration or vertical acceleration.

28. Method as defined in claim 27 wherein the rotation rate along the primary direction is the yawing rate of the motor vehicle and the rotation rate along the additional direction is the rolling rate or pitching rate.

29. Method as defined in claim 28 wherein the lateral inclination of the motor vehicle is calculated with the aid of the calculated rolling rate along the additional direction.

30. Method as defined in claim 29 wherein a measured transverse acceleration is corrected by means of the calculated lateral inclination.

31. Method as defined in claim 30 wherein the float angle velocity is calculated with the aid of the corrected transverse acceleration.

32. Method as defined in claim 24 wherein the tolerance of the controller of a driving dynamics system of a motor vehicle is increased or said controller is turned off when the deviation between the measured values of the first and the second sensor exceeds a certain threshold value, the position to the angle of the measuring directions of the sensors to one another being taken into account in the comparison of the measured values.
